(19) United States
(12) Patent Application Publication
(10) Pub. No.: US 2003/0006260 A1
(43) Pub. Date: Jan. 9, 2003

(54) Storage means for automobile anti-theft device

(76) Inventor: Jackie W. Bassett, Carlisle, PA (US)

Correspondence Address: Jackie W. Bassett, 351 B Street, Carlisle, PA, 17013, US

(21) Appl. No.: 09/900,815

(22) Filed: Jul. 9, 2001

(51) Int. Cl. B60R 7/00

(52) U.S. Cl. 224/275; 224/572

(57) ABSTRACT

The invention discloses storage means for an automobile anti-theft device comprising an elongated substantially rectangular receptacle for storing therein a bar-shaped anti-theft device, commonly known as “Club”. Mounting means, such as straps, extending from the receptacle serve to attach the receptacle upon the rear surface of the back of an automobile seat, preferably the back of the front passenger seat.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

This invention relates to storage means for an automobile anti-theft device, particularly to a bar type device generally known as and sold under the trademark “Club”. This device is applied to and locked upon the steering wheel of an automobile for securing the automobile. Subsequently, for rendering the automobile steerable the device must be removed from the wheel.

The so-called “Club” device is a relatively heavy and un-wieldy implement. When removing the device from the steering wheel for rendering the automobile driveable, most drivers will place the device on the floor of the automobile or on a passenger seat. In the event of a collision or sudden stop, the unsecured device may be hurled against the driver or a passenger, possibly inflicting serious injury.

The present invention overcomes this potentially hazardous condition by providing a storage means for securely storing the anti-theft device when it is not in use. To this end, the storage means includes means for mounting it upon the exposed rear surface of the back of an automobile seat, preferably the front passenger seat. In this manner, when the anti-theft device is not in use and the automobile is in motion, the hazardous condition indicated above is safely avoided.

### BRIEF SUMMARY OF THE INVENTION

This invention discloses storage means for an automobile anti-theft device comprising an elongated, substantially rectangular, receptacle for removably storing therein a bar-shaped anti-theft device, commonly known as “Club”. Mounting means, such as straps, extending from the receptacle serve to attach the receptacle to the rear surface of the back of an automobile seat, preferably the front passenger seat. The receptacle may be made from leather or synthetic material and may include padding for safety purposes.

An important object of this invention is the provision of a storage means for securely storing a relatively heavy automobile anti-theft device in an automobile when the device is not in use.

Another important object of this invention is the provision of a storage means for safely storing a heavy mechanical automobile anti-theft device when the device is not in use so that in the event of an accident, such as a collision, the device is unable to harm a person.

A further important object of this invention is the provision of a storage means for storing an automobile anti-theft device in an automobile when the automobile is in motion, the storage means including mounting means for mounting it upon the rear surface of the back of an automobile seat.

A still further and important object of this invention is the provision of a storage means attachable to an automobile seat for storing a common anti-theft device, known as “Club”, when the device is not attached to the automobile steering wheel.

Further and still other objects of this invention will become more clearly apparent from the following description when taken in conjunction with the accompanying drawings.

### BRIEF DESCRIPTION OF THE SEVERAL VIEWS OF THE DRAWING

FIG. 1 is a front elevational view of a typical and preferred embodiment of the storage means forming the present invention;

FIG. 2 is a side view of the embodiment per FIG. 1;

FIG. 3 is an elevational view of an alternative embodiment of the storage means;

FIG. 4 is an elevational view of a further embodiment of the storage means;

FIG. 5 is an elevational view of another alternative embodiment of the invention;

FIG. 6 is an elevational view of another alternative embodiment of the storage means per the present invention;

FIG. 8 is an elevational view of a still further embodiment of the present invention;

FIG. 9 is a top plan view of a clip shown schematically in FIG. 8;

FIG. 10 is an elevational view of a spring and hook fastening device useful for attaching the storage means to an automobile seat, and

FIG. 11 is an elevational view of a typical automobile seat with a storage means of the present invention attached thereupon.

### DETAILED DESCRIPTION OF THE INVENTION

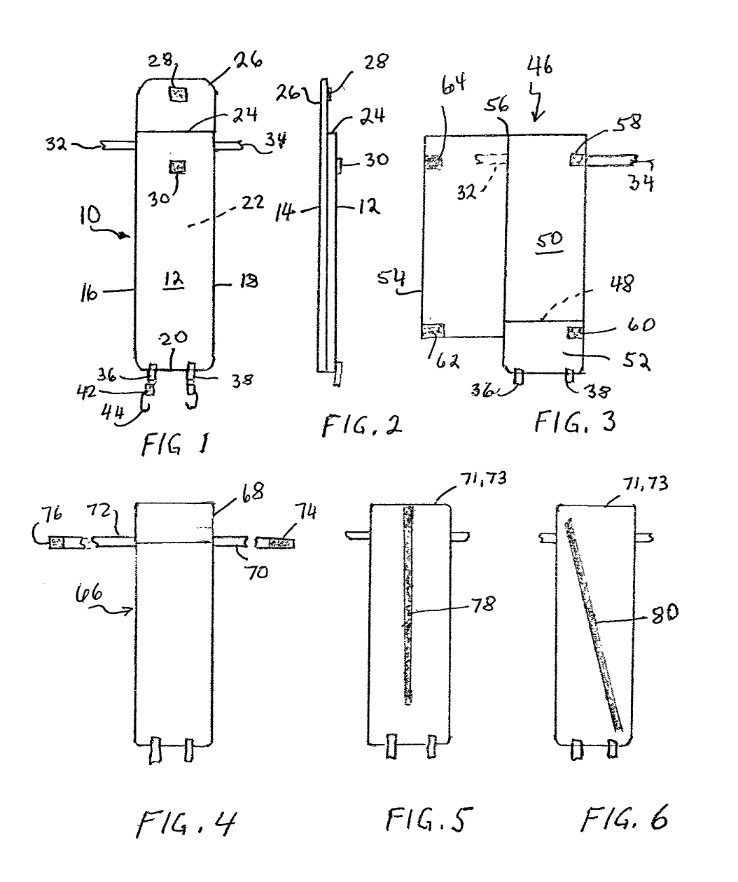

Referring now to the figures and FIGS. 1 and 2 in particular, there is shown a typical embodiment of the storage means in the form of an elongated, substantially rectangular, receptacle 10 comprising a front panel 12 and a superposed rear panel 14, both joined along their side edges 16 and 18, and along their bottom edges 20. The joined panels thus provide an interior space or pocket 22 for receiving and storing therein an elongated bar-shaped automobile anti-theft device, known as “Club”. The rear panel 14 extends above the upper edge 24 of the front panel 12 to form a flap 26, which can be folded over upon the front panel 12 for closing the pocket when the anti-theft device has been placed into the pocket. Complementary closure means 28 and 30, such as strips of VELCRO, snap button combinations or similar commercially known means, are provided between the flap 26 and the front panel 12 to retain the flap 26 in its closed position.

The panels 12 and 14 may comprise leather or other suitable natural or synthetic flexible material and may include padding for cushioning the edges of the device and to provide a soft impact for a person brushing thereagainst.

In order to mount the receptacle 10 upon the rear surface of the back of an automobile seat, there is provided an upper set of straps 32 and 34 extending from the upper portion of the receptacle 10, for reaching around the edge of the back of the automobile seat and for coming together at the front or at the side of the back of the seat. Known closure means, not shown in FIG. 1, are used to engage and secure the distal ends of the straps 32, 34 to one another. Typical closure means include buckles, clasps, hook-eye and loop means, VELCRO strips, etc.

A further set of straps 36 and 38 extend from the lower portion or end of the receptacle and in a typical embodiment each strap or fastening means includes an elastic cord 40 terminating in a conical spring 42 and hook 44, see FIG. 10. The respective hooks 44 preferably engage the understructure of the automobile seat. In this manner the strap means securely fasten the receptacle 10 to the automobile seat.

FIG. 3 discloses an alternative embodiment of the storage means. The receptacle 46 exhibits a relatively shallow pocket 48 at its lower portion. The pocket is formed by a back panel 50 and a superposed short front panel 52. The open upper portion of the back panel can be covered by a side panel 54 attached to the back panel and adapted to fold over along edge 56 to provide for the enclosure of the anti-theft device. Closure means, such as suitable strips 58, 60, 62, 64 of VELCRO material serve to retain the receptacle panel 54 closed.

FIG. 4 shows a receptacle 66 substantially similar to that shown in FIG. 1, except that the rear panel 68 is without the flap 26 seen in FIG. 1. FIG. 4 also shows a set of upper straps 70, 72 both provided at their respective distal ends with suitable complementary closure means 74 and 76.

FIGS. 5 to 7 show still further embodiments of the invention. A pair of substantially identically sized panels 71, 73 are superposed upon one another and joined along their edges, thus providing an internal pocket for storing the anti-theft device. In FIG. 5 a substantially vertical closure means 78, such as a Zipper, provides an opening or closure for the pocket. FIG. 6 shows a similar but diagonally arranged closure means 80, and FIG. 7 shows a horizontally disposed top closure means 82. The respective closure means is opened for insertion and removal of the anti-theft device and is closed when the device is stored.

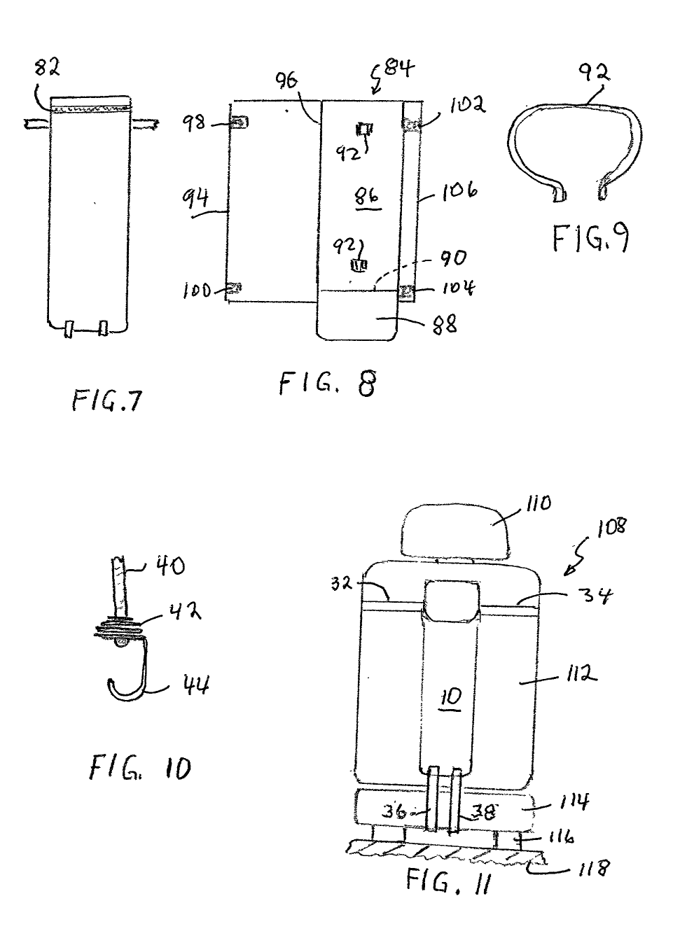

Another variation of the storage means is shown in FIG. 8. The receptacle 84 includes a rear panel 86 and a short front panel 88 to form a relatively shallow bottom pocket 90. The rear panel 86 includes two vertically spaced clips 92, shown in greater detail in FIG. 9, for receiving therein round bar portions of the device. The lower end of the device is stored in the pocket 90 while the mid-section and upper portion of the device are retained in the clips 92. A side panel 94 foldable along vertical edge 96 serves to fully enclose the device. Closure means 98, 100 are adapted to engage closure means 102, 104 of the strip 106 to fully cover the anti-theft device.

FIG. 11 illustrates the storage means attached upon an automobile seat. Numeral 108 denotes a typical automobile front seat as viewed from the rear, comprising a head rest 110, the exposed rear surface 112 of the back of the seat, the seat portion 114 and feet 116 which anchor the seat 108 to the floor or chassis structure 118 of the automobile.

The receptacle 10 per FIG. 1 is shown attached in a substantially vertical direction upon the rear surface 112 by straps 32 and 34 extending from the upper portion of the receptacle 10 girding the backrest of the seat, and by straps 36 and 38 extending from the lower portion of the receptacle 10. As previously stated, the lower portion straps 36, 38 at their distal ends are provided with a respective hook, see FIG. 10, for engaging the understructure of the seat portion 114. Also, as stated heretofore, in the preferred mode the receptacle is attached to the exposed rear surface of the front passenger seat.

While there have been described and illustrated several preferred embodiments of the invention, it will be apparent to those skilled in the art that various additional changes and modifications may be made without deviating from the broad principle of this invention, which shall be limited only by the scope of the appended claims.

I claim:

1. Storage means for attachment to the back of an automobile seat and for storing therein a bar-shaped automobile anti-theft device when said device is not in use, said storage means comprising:
an elongated substantially rectangular receptacle having a pocket for storing therein the anti-theft device, and
strap means extending from said receptacle for attaching said receptacle upon the rear surface of the back of an automobile seat.

2. Storage means as set forth in claim 1, said receptacle being attachable upon said surface in a substantially vertical direction and exhibiting then an upper portion and a lower portion; said strap means including at least a first strap extending from a location along said upper portion for girding the back of an automobile seat, and at least a second strap extending from a location along said lower portion and including means for engaging a lower part of said automobile seat.

3. Storage means as set forth in claim 2, said second strap including an elastic cord and said means for engaging a lower part of the automobile seat comprising a hook disposed at the distal end of said strap.

4. Storage means as set forth in claim 3 and including a flap for closing said pocket, and complementary closure means disposed on said receptacle and said flap for retaining said flap in a position in which said pocket is closed.

5. Storage means as set forth in claim 3, said receptacle including at least one spring clip for receiving therein a round bar portion of said anti-theft device.

6. Storage means as set forth in claim 3, said receptacle comprising a rear panel and a superposed front panel, both panels joined at edges for providing said pocket; said rear panel including at least one spring clip for receiving therein a round bar portion of the anti-theft device, and said receptacle including further a foldable side panel extending from said rear panel for covering a portion of said rear panel and device disposed in said pocket.

7. Storage means as set forth in claim 3, said receptacle comprising a rear panel and a superposed front panel, both panels joined at their edges for providing between said panels said pocket, and closure means disposed at said front panel for providing access and closure for said pocket.

8. Storage means for attachment to the back of an automobile seat and for storing therein a bar-shaped automobile anti-theft device when said device is not in use, said storage means comprising:
an elongated substantially rectangular receptacle having a pocket for storing therein said anti-theft device;
a first set of straps extending from said receptacle for girding the back of an automobile seat, and
a second set of straps extending from said receptacle for engaging an understructure portion of such automobile seat.
